(19) United States
(12) Patent Application Publication
(10) Pub. No.: US 2014/0278690 A1
(43) Pub. Date: Sep. 18, 2014

(54) ACCOMMODATING SCHEDULE VARIANCES IN WORK ALLOCATION FOR SHARED SERVICE DELIVERY

(71) Applicant: International Business Machines Corporation, Armonk, NY (US)

(72) Inventors: Shivali Agarwal, Ghaziabad (IN); Yi-Min Chee, Yorktown Heights, NY (US); Juhnyoung Lee, Yorktown Heights, NY (US); Rong Liu, Sterling, VA (US); Vinay K. Reddy, Bangalore (IN); Renuka Sindhgatta, Bangalore (IN); Lav R. Varshney, Yorktown Heights, NY (US); Jeaha Yang, Stamford, CT (US)

(73) Assignee: International Business Machines Corporation, Armonk, NY (US)

(21) Appl. No.: 14/029,057

(22) Filed: Sep. 17, 2013

Related U.S. Application Data
(63) Continuation of application No. 13/835,404, filed on Mar. 15, 2013.

(51) Int. Cl. G06Q 10/06

(52) U.S. Cl. CPC G06Q 10/063116
USPC 705/7.22

(57) ABSTRACT

Accommodating schedule variance in work, in one aspect, may comprise tracking information associated with work packets; identifying one or more work packets deviating from a planned schedule based on the tracking; identifying one or more features associated with the identified one or more work packets; computing metrics associated with the one or more features; prioritizing the identified one or more work packets based on the computed metrics using a predictive model, the predictive model calibrated at least based on historical data; and recommending one or more actions to take associated with the one or more prioritized work packets.

### CROSS-REFERENCE TO RELATED APPLICATIONS

This application is a continuation of U.S. Ser. No. 13/835,404, filed on Mar. 15, 2013, the entire content and disclosure of which is incorporated herein by reference.

### FIELD

The present application relates generally to computers, and computer applications, and more particularly to global shared service delivery in information technology systems and schedule variances thereof.

### BACKGROUND

A project in the shared service delivery model inevitably undergo changes in the schedule of tasks, for example, whether it be for the reason of unexpected events such as work has not started as planned, work has not ended as planned, work has been put on hold, lack of availability of practitioners, and/or another reason. Work undergoing schedule variances often affect the performance adversely in global service delivery. However, identifying and analyzing all these variances and changing the plans accordingly, is challenging, complex, tedious and time consuming. The existing solutions are limited to manual, ad-hoc tracking and prioritizing of work packets (or tasks) by a pool lead. Task prioritization in the event of schedule variances is typically limited to a single project. While the existing practice defines and generates an optimal plan for allocation of work, the effectiveness of the optimal plan is hampered because schedule variances are not effectively and continuously tracked, predicted and handled in planning.

### BRIEF SUMMARY

A method of accommodating schedule variance in work, in one aspect, may comprise tracking information associated with work packets. The method may also comprise identifying one or more work packets deviating from a planned schedule based on the tracking. The method may further comprise identifying one or more features associated with the identified one or more work packets. The method may further comprise computing metrics associated with the one or more features. The method may also comprise prioritizing the identified one or more work packets based on the computed metrics using a predictive model, the predictive model calibrated at least based on historical data. The method may also comprise recommending one or more actions to take associated with the one or more prioritized work packets.

A system for accommodating schedule variance in work, in one aspect, may comprise a resource and work packet tracking subsystem operable to track information associated with work packets, and further operable to identify one or more work packets deviating from a planned schedule based on the tracking. A feature processing subsystem may be operable to collect data associated with the identified one or more work packets and further operable to identify features associated with the identified one or more work packets, and compute metrics associated with the features. A prioritization model may be operable to prioritize the identified one or more work packets based on the computed metrics of the features, the prioritization model calibrated at least based on historical data. One or more actions to take may be recommended for the one or more prioritized work packets.

A computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE SEVERAL VIEWS OF THE DRAWINGS

FIG. 1 is a flow diagram illustrating tracking of schedule variances in one embodiment of the present disclosure.

FIG. 2 illustrates various features for prioritization in one embodiment of the present disclosure.

FIG. 3 illustrates a decision tree learning example suggesting actions in one embodiment of the present disclosure.

FIG. 4 is a flow diagram illustrating a method for tracking variance in work schedule, prioritizing and re-planning work schedule in one embodiment of the present disclosure.

FIGS. 5A and 5B illustrate an example of real-time task monitoring for variances in one embodiment of the present disclosure.

FIG. 6 illustrates an example output plan that is generated in one embodiment of the present disclosure.

FIGS. 7A and 7B illustrate a system for tracking and prioritizing tasks and/or work packets in one embodiment of the present disclosure.

FIG. 8 illustrates a system in another aspect, for tracking and accommodating for schedule variance in one embodiment of the present disclosure.

FIG. 9 illustrates a schematic of an example computer or processing system that may implement a system in one embodiment of the present disclosure.

### DETAILED DESCRIPTION

A system and method may be provided for dealing with schedule variances systematically. In one aspect, real-time tracking and monitoring of tasks and resources may identify different types of schedule variances using rules and semantic models. In another aspect, prediction models using techniques such as Bayesian Ordinal-based regression/Classification and, for example, Network Analysis may measure for WBS for prioritization of tasks. Yet in another aspect, dynamic generation of new plans may be provided for work allocation incorporating changes to key tasks. Still yet in another aspect, model calibration may be performed driven by data and prior beliefs of experts.

A global service shared delivery model refers to a model used by companies engaged in information technology (IT) consulting and services delivery business to execute a technology project using globally distributed resources. Such delivery model may focus on technical skills, processes or methodologies, tools, structure and strategies for delivering IT services from sources or services located globally, e.g., different physical locations in the globe. Such global service delivery may better cater to local customers, e.g., due to better understanding of local language and culture, and thus better understanding of the local customer requirements. Such global service delivery also may provide round the clock service for its customers. In addition, such global service delivery may provide a degree of “risk-proofing” from possible natural or man-made disasters, as the service is distributed across the global locations.

In a global shared service delivery model, a pool of resources or people are responsible for delivering components, for different customers and projects. For example, practitioners work on atomic units of work or tasks they are responsible for and the units of work may be associated to different projects and customers. A project of a customer may include a plan with different components being developed by different pool of resources. A lead of a resource pool is responsible for ensuring the atomic units of work assigned to the team is delivered on time and as per schedule. If there are any changes in the schedule of the tasks and/or availability practitioner pool (e.g., person falling sick, attending training), variances in the schedule need to be accommodated in plans of the projects the tasks belongs. The same change should also be accommodated in the assignments/tasks lists of the practitioners. There can be several schedule variances in the global delivery model where the pool of practitioners can be large (e.g., >50) with the pool supporting more customers and projects. Identifying and analyzing all these variances and changing the plans accordingly can be challenging, complex, tedious and time consuming. Each change in plan may require additional inputs—whether a task needs to be re-assigned, additional time required etc. Also, the lead may need to prioritize the tasks having a high impact due to their schedule variances. The prioritization of tasks may be important for the lead to take action and re-plan the critical tasks. For example, a one hour task getting delayed by 5 hours may be of a low importance as compared to a 40 hour tasks getting delayed 10 hours. A code review task on-hold may not be as critical as “testing software” task not starting due to unavailability of test setup. The prioritization of the tasks may be based on several criteria. Each criterion may need to be identified, weighed and used. For instance, criteria may include one or more of type of tasks, schedule variance of the tasks, customer of the tasks, priority of the project the task belongs to, dependencies of the task, the skill level required for the tasks. A predictive model may prioritize the tasks based on different features of the tasks and assigned practitioners. Important tasks may need to be re-planned to ensure that the new information about the additional time, expected start or end date is entered to ensure all plan is updated and accurate. Tasks with variance that are considered to be critical/top rated may be re-planned by prompting the lead for additional inputs and a new plan may be generated to accommodate the variances.

An embodiment of the present disclosure helps the lead/project manager or the like to determine whether the work going on as planned, e.g., by tracking work, identifying variances and categorizing the variances. Further, tasks are likely to get delayed (e.g., and the delay duration) or have missed deadline, may be identified. In addition, tasks that need attention may be identified, e.g., by computing features related to the tasks such as type of delay, priority of the task, delay propagation, customer of the task, and resource assigned to the task. A prediction model may be built to determine priority. In addition, one or more actions the lead take should take may be identified, e.g., continue the task and generate new plan, plan with a new start date, or suspend the task.

A methodology in the present disclosure in one embodiment may track and prioritize work packets/tasks that need to be re-planned due to change events. In the present disclosure, the terms work packet and task are used interchangeably to refer to a unit of work. In one aspect, the methodology may perform the following functions: monitor and identify the types of schedule variances from the plan; compute task, resource, customer and network features for each instance of the variance; prioritize variances based on the features using Bayesian Ordinal Regression; alert lead and suggest action on the variances using a decision tree; generate a plan that accommodates the variances; and calibrate a model based on historical data and expert beliefs.

Status monitoring of work packets and resources in one aspect may comprise real-time tracking and monitoring of all tasks based on status to identify the type of non-adherence, and identifying and computing features related to the task, resource, and/or plan. Model-based prediction of work packet priority in one aspect may comprise using a predictive model such as Bayesian ordinal-based regression to identify priority based on different parameters of the task. Possible actions may be suggested to generate a new plan, e.g., based on the type of variance and measures related to task/work packet. Dynamic generation of a new plan incorporating changes to key tasks may comprise collecting additional data, e.g., if needed, from the lead and/or task owners, and incorporating the top N tasks to generate a new plan that accounts for the variances. N may be a configurable number.

Examples of types of variances may include, but are not limited to: “Task has Not Started as planned”, in which case when the work would started should be identified; “Task has Not Ended as planned”, in which case when the task get would get completed should be identified; “Higher effort required to complete the task”, in which the effort for completing the task has changed (increased/reduced); “Task is put On Hold as it need additional inputs”, in which the remaining tasks can be worked upon/wait for completion of the task; and “Resource working on the task is Unavailable”, in which the task needs to wait for the resource to become available or be re-assigned to another resource.

In one embodiment of the present disclosure, a rule-based tracking system and/or methodology for identifying variances may comprise an automatic agent/daemon/cron that, e.g., periodically, identifies all the schedule variances that have been configured in the system. An agent/daemon/cron may be a program that runs automatically in a computer system. A set of conditions can be configured in the system to associate a type of schedule variance. These conditions are verified in the database of resources and work packets. In one embodiment of the present disclosure, the schedule variance configuration is extensible and multiple schedule variance types can be added.

Table 1 illustrates examples of schedule variance configuration, which configures for detection of schedule variances.

| Schedule Variance Type | Condition | Description |
|---|---|---|
| NOT_STARTED | currentTime > workpacket.startdate | Condition to identify |
| | and | workpacket has not |
| | workpacket.status = ASSIGNED | started. |
| | | Workpacket.startdate is |
| | | the planned (e.g., |
| | | originally planned) start |
| | | date of the work. |
| NOT_ENDED | currentTime > workpacket.enddate | Condition to identify |
| | and | workpacket has not |
| | workpacket.status = INPROG | ended. |
| | | Workpacket.enddate is |
| | | the planned (e.g., |
| | | originally planned) end |
| | | date for the work. |
| ON-HOLD | currentTime − workpacket.holdtime >= | Condition to identify |
| | 0.8 * workpacket.effort | workpacket on hold for |
| | | 80% of the time |
| | | allocated. |
| | | Workpacket.holdtime |
| | | specifies the amount |
| | | time the work is put on |
| | | hold. |
| | | Workpacket.effort |
| | | specifies the amount of |
| | | effort (e.g., number of |
| | | hours) needed for the |
| | | work. |
| RESOURCE_UNAVAIL | workpacket.resource = resource and | Condition to identify |
| | resource.calendar.status = | that a resource assigned |
| | UNAVAILABLE | to the work packet is |
| | | not available based on |
| | | his/her calendar |
| | | information |

FIG. 1 is a flow diagram illustrating tracking of schedule variances in one embodiment of the present disclosure. Schedule variance configuration 102 may be read and used by one or more computer processes (e.g., agent programs, daemon or cron) 104, e.g., running in the background or foreground, to track tasks and resources. Data stored in a database of work packet and status 106 or the like, and data stored in a database of resources and calendar 108 or the like, may be checked and compared to determine whether one or more conditions (or criteria) specified in the schedule variance configuration 102 is satisfied. The data that meets such condition are identified as variances.

In one aspect, the determining of whether a deadline is missed or likely to be missed may include the following computation. Let the set of alarming tasks (missing/likely to miss deadline) be where P indicates the project, w indicates the tasks and D indicates the variances related to each task:
a. P1→w11(D1), w12 (D2), w13 (D3), . . .
b. P2→w21′(D1′),w22′(D2′),w23′(D3′), . . .
   Tasks needing attention depends on several parameters that may not be evident to a lead. The features are based on different attributes of the task. For example, a code review type of work packet that has not started need not be re-planned if the assigned practitioner in the past has always completed the task on time. Tracked variances are prioritized in one embodiment of the present disclosure.

FIG. 2 illustrates features for prioritization in one embodiment of the present disclosure. Features for determining importance of a task, for example, may comprise work packet/task related features 202, dependency network measure 210, resource related features 204, customer related features 206, and project related features 208. Work packet/task related features 202 may comprise work packet type 212 that may identify the importance of this work packet for prioritization. For example, a development work packet may be considered as more important compared to a review task. Work packet/task related features 202 may also comprise an estimated effort for completing a work packet 214. A lower effort work packet would have lower impact on the overall project plan. Work packet/task related features 202 may also comprise information associated with deviation from the plan 216.

Plan is a network of dependent tasks. The importance of a task may be determined by dependency network measures 210 such as flow centrality and degree centrality. Dependency network measures 210 may also include delay propagation, which is propagation/impact of the change in the schedule of the work packet.

Resource related features 204 may comprise skill level of the resource 218 for the given task, role of the resource 220 for the given task, and a plan adherence index 222 that determines the adherence to the plan by the resource based on history, e.g., percentage of tasks completed as per plan by the person.

Customer related features 206 may comprise the relative ranking 224 of the customer the task belongs to, and a plan adherence index 226 for the given customer based on the historical work done. If the plan adherence has been low in the past, the task belonging to the customer needs to be prioritized.

Project related features 208 may comprise the relative priority 228 of the project for the customer, and a plan adherence index 230 for the project, e.g., based on the number of tasks of the project that have adhered to the plan.

Network of dependencies 210 may use network metrics. The work break down structure may contain the list of tasks that have dependencies. A network of dependencies between the tasks that are assigned to a pool of people can be created within a specific planning cycle. The weight of a dependency link can be defined based on the successor task. For example, it may be set to w, if task and its successor belong to the same project and are done by the same person. It may be set to raw if the tasks and its successor belong to different projects and are done by different practitioners. Degree centrality 234 refers to the number of direct dependent tasks a task has. A high degree centrality indicates: The late finish of this task would impact several other tasks; The earliest finish of the task depends on several other tasks. Flow centrality 232 indicates the importance of the task in the network, e.g., the impact of this task on the execution plan of several other tasks, and represents the single point of failure. Failing to complete this task would impact several others. Delay propagation 236 indicates impact of delay on the dependent tasks.

The above features values may be computed based on information associated with the task or work stored in a database or the like.

Based on the features, a prediction model identifies priority of the task to be attended to. In one embodiment of the present disclosure, the prediction model may be a Bayesian Ordinal regression model as described below.

The relative priority θⱼ of a task i, t, depends on different features x₁ . . . xₙ of the task. The Bayesian Ordinal logistic model can be represented as ln(θⱼ)=αⱼ−βX where X={x₁ . . . xₙ}, where j takes values from 1 to the number of priorities −1, αⱼ is the intercept or threshold for the j-th category, and β is the regression coefficient. For example, if the number of priorities for categorizing the tasks on the basis of importance is set as 5, with 1 indicating a very high priority variance and 5 indicating a not so important schedule variance, j would be set to 5−1=4. The ordinal regression would categorize each task in the variance list with values ranging from 1 to 5.

The features or the independent variables are computed for each task t. A model is fitted based on the historical data collected for each task and prior knowledge from experts and the priority as labeled by the lead.

To train or calibrate the ranking model, the following steps may be performed. For several pairs of work packets, a plurality of experts may be asked as to which was more important between the two. Zermelo's method or iterative rank aggregation algorithms may be used to produce a scalar scoring of the various work packets. The score may be converted to Ordinal ranks for variances. The training data (e.g., ranked variances) may be used to calibrate regression model.

FIG. 3 illustrates a decision tree learning example suggesting actions in one embodiment of the present disclosure. In response to detecting schedule variance 300, a methodology in one embodiment of the present disclosure may suggest one or more actions to be taken. In one embodiment, the recommendation may be based on decision tree learning. For instance, for each type of variance, the decision tree learning methodology of the present disclosure may compute the features of the task and suggest actions for the lead. For example, if a task was delayed but does not have any dependencies, the lead can suspend the task and resume with a new date. If the task has several dependencies, the lead should generate a new plan with the new effort and new end date. Based on the type of schedule variance detected (e.g., at 300) and different feature values identified or computed, different actions may be recommended. For example, at 302, if as a result of tracking it is determined that a condition that a person is not available is met, additional features are compared. For example, at 304, if a skill feature is high, plan adherence index is high and unavailable days is low, a suggestion to generate a plan with the same person may be made at 306. On the other hand, at 308, if skill is high, plan adherence index is low and unavailable days is low, a suggestion to generate a plan reassigning a task may be made at 310. Similarly, at 312, if as a result of tracking it is determined that a task has not ended, additional features are compared to determine what recommendations should be made. For example, if delay propagation value is high, variance is high, degree of centrality is high and flow of centrality is high at 314, a recommendation may be made to generate a plan with new end data and effort at 316. At 318, if delay propagation value is low, variance is high, degree of centrality is low and flow of centrality is low, a suggestion is made to suspend the task with a new resume date at 320. Likewise at 322, if as a result of tracking it is determined that a task has not started, additional features are compared to determine what recommendations should be made. For example, if delay propagation value is high, variance is high, degree of centrality is high and flow of centrality is high at 324, a suggestion is made to generate a plan with new start date at 326. On the other hand, if delay propagation value is low, variance is high, degree of centrality is low and flow of centrality is low at 328, a recommendation to suspend the task with new resume date may be made at 330.

A decision tree model for actions, such as the one shown in FIG. 3 may be built based on training data. For example, a sample set of work packets may be selected for training based on customer, project and work packet type and variance. The action taken by a lead or the like may be determined, e.g., based on audit trail and by explicit input from such lead or the like. Using the training data (sample set of work packet data with associated feature information such as customer, project, work packet type and variance, and the related action taken by a lead), a decision tree model may be built. For instance, a decision tree classifier may be used to build the model.

FIG. 4 is a flow diagram illustrating a method for tracking variance in work schedule, prioritizing and re-planning work schedule in one embodiment of the present disclosure. At 402, tracking or monitoring is performed, for example, as a background or foreground process in a computer system, to determine work and/or resources that deviate from the original or initial work plan or schedule. As an example, tracking agent may be run to identify different non-adherences of work packets to the existing plan. The tracking agent or the like may utilize status and event based identification of specific non-adherences. For example, the tracking agent may receive even signal or interrupt in case of non-adherence. In another aspect, semantic model based identifying of types of non-adherences may be used. For example, whether there is deviation may be detected based on a configurable schedule variance configuration, an example of which is shown in Table 1. Tracking, for instance, may comprise observing status and amount of time spent associated with the work packets and comparing the observed status and amount of time with an estimation. The estimation may be configured as a semantic model, wherein the semantic model may be configurable by a user.

At 404, metrics are computed for the identified features. For instance, features associated with the work that is detected as having a schedule variance, are identified, and values for those features are computed or obtained. The values may be obtained or computed from a database storing information about the work and about the resources assigned to the work.

At 406, priority of tasks is predicted for re-planning, for example, based on a prediction model. For instance, a prediction model may be calibrated based on historical data and feedback input from users. For example, at 408 relative priority data associated with different tasks having different features may be collected. At 410, a prediction model may be calibrated (built) based on the collected data.

In one aspect, the predictive model uses different features to learn and predict the priority of work packets to be re-planned. For example, a key set of features are identified and defined; Historical data is collected where a lead or the like user, has provided feedback on the priority of work packets having schedule variances; metrics is collected for all the features and network measures are computed to identify the impact of the work packet non-adherence to schedule; the predictive model is built based on learning approaches such as Classifiers, and/or Ordinal Regression. The predictive model then may predict and prioritize the work packets marked by the monitoring agent for non-adherence.

At 412, based on prioritization output by the prediction model, tasks that need re-planning are identified. For example, the prediction model may rank the work or tasks that are detected as having schedule variance. In one embodiment of the present disclosure, work packets or tasks ranked at top determined number (e.g., N) may be identified for re-planning. N may be a configurable number, configurable by a user. In one aspect, a task that can be automatically planned (e.g., without additional user input) may be identified. In another aspect, if the identified task for re-planning needs additional input, the additional input data may be collected as described below with respect to 416.

At 414, one or more action may be suggested, for instance, using decision tree learning, e.g., as described with reference to FIG. 3.

At 416, it is determined whether additional input is needed. For instance, a user may select one or more recommendations suggested at 414. In response, additional input may be needed to implement those actions. For instance, for generating a new plan, additional information such as a new start date, amount of effort required, and/or other data may be needed. If no additional input is needed, the logic of the method proceeds to 420.

At 418, in response to determining that additional input is needed, the additional input may be collected for prioritized tasks, for example, from a user or from existing information available in a database or the like. If no additional input is needed, the logic of the method proceeds to 420.

At 420, a new plan may be generated. A capacity planner, for example, may generate a new schedule.

FIGS. 5A and 5B illustrate an example of real-time task monitoring for variances in one embodiment of the present disclosure. Tracking of work packets by an automated tracking agent (e.g., a computer program or instructions running automatically on a computer system) may provide a list of work packets 502 that are not adhering to the schedule. Given the list of work packets 502, a prioritization model of the present disclosure in one embodiment may identify which of these work packets' non-adherence should be attended to first (e.g., because it is critical to an operation of a business), and prioritize the work packets that need action to be taken. The prioritization may depend on multiple features—customer, project, type of work packet, etc. For example, a methodology of the present disclosure in one embodiment may extract features of the work packets and use a predictive model and prioritize to highlight important tasks impacting the current plan. An example of a prioritized output is shown at 504, for example with rankings enumerated at 506. Tasks with high priority may be re-planned with suggested actions. An example of suggestions output for the high priority tasks is shown at 508. Inputs such as new start date, new end date, additional effort needed are used to generate a revised plan 510.

FIG. 6 illustrates an example output plan that is generated in one embodiment of the present disclosure. In this example two pools (or project teams) support four different projects belonging to different clients. A monitoring agent of the present disclosure in one embodiment detects schedule variances in the tasks, marked ‘X’ in the plan shown at 602 (two tasks assigned to R10, one task assigned to R22, one task assigned to R23). A prediction model of the present disclosure in one embodiment prioritizes the tasks performed by R22 and R23 as the important tasks (ordinal rank is high) based on different features computed for the four tasks. Also based on the features of R22 and R23, a suggestion to generate a new plan may be made. At 604, additional input associated with the tasks is obtained, e.g., from a project lead. Examples of the additional input may include additional amount of work or effort needed for the tasks, and new start date. Other input data may be obtained as needed for the new plan. At 606, a new plan is output that accommodates the late start of task T2, and additional effort needed for task T1.

FIGS. 7A and 7B illustrate a system for tracking and prioritizing tasks and/or work packets in one embodiment of the present disclosure. The work packets (e.g., 716, 718, 720) assigned to the practitioners (e.g., 710, 712, 714) are tracked, e.g., by observing the status and actual hours spent against estimation. The schedule variance configuration 708 is used to track and identify work packet or resources that need to be flagged for non-adherence. In one embodiment of the present disclosure, the configuration 708 can be captured in a semantic model. Thus, for example, a resource and work packet tracking subsystem or module 702 may monitor a database or the like that stores information about resources 704 and also a repository or the like that stores information about work packets 706. The resource and work packet tracking subsystem 702 may receive a schedule variance configuration 708 that lists conditions that would indicate a variance or deviation in a planned schedule. The resource and work packet tracking subsystem 702 may check information in the database or the like that stores information about resources 704 and also the repository or the like that stores information about work packets 706, and detect whether the checked information meet the conditions specified in the schedule variance configuration 708. The work packet repository 706 may be updated and/or input with information about the work packets/tasks, for example, by respective workers or leads (e.g., 710, 712, 714) handling the work packets (e.g., 716, 718, 720). Such information may include, but is not limited to, type of work, start by date, end by date, status, and others.

Data is collected for the work packets and the features/metrics are computed. For example, in case of task network measures, the data may be collected in the form of graph, and processed to transform the graph form into metrics like between-ness centrality. A feature processing system 722 identifies various features associated with the work packets/tasks, and computes values for the features, for instance, using the information stored in the work packet repository 706.

The computed metrics may be fed to a model 726 to predict the priorities of the tasks for re-planning. For instance, the information and feature values associated with the one or more work packets identified as having schedule deviation are input to the model 726 for the model to prioritize the work packet/task. One or more actions may be suggested for the prioritized work packets/tasks.

A model calibrator 724 builds or calibrates a predictive model 726, e.g., classification, ordinal regression or another model, based on historical and/or user such as an expert data. The model 726 may be periodically calibrated based on additional data collected to keep the model up-to-date and to incorporate the feedback from the workers or leads or the like, on predicted priorities and the actual priority as ascertained by, e.g., the lead or the like.

Additional information if needed may be obtained and input to a capacity planner module 728 for generating the new plan. For example, once the tasks are prioritized a new plan may be generated based on additional inputs from a user or the lead or the like, for the identified tasks. Additional input may include, but is not limited to, additional time required, new start date, new end date, and/or other information. Tasks that do not need any additional inputs may be automatically re-planned by the capacity planner subsystem, e.g., if their priority is greater than a set threshold value.

In one embodiment of the present disclosure, a management portal 734 allows a user such as the lead to view the prioritized tasks, generate a new plan and interact with the overall system. For example, via this portal 734, a lead may be able to view all the tasks and their priorities. Also via the portal 734, the lead can further make a change to the task priority which is taken as a feedback to calibrate the model. The prioritized tasks 732 output from the prediction model 726 and one or more suggestions for actions may be presented via a user interface of the portal 734 or the like. A lead or like user can further make a change to the priority, which change may be taken as a feedback to further calibrate the predictive model 726. The generated plan may be presented to a user 730 via the portal 734. The portal 734 may also be used to receive, from a user, additional information about the one or more work packets and/or tasks used for generating a new plan. In one aspect, the management portal 734 may include a web interface or another user interface for enabling users to input data and view presented data.

FIG. 8 illustrates a system in another aspect, for tracking and accommodating for schedule variance in one embodiment of the present disclosure. A tracking and prioritization module or subsystem 802 may comprise a resource and work packet tracking subsystem 804, a feature processing subsystem 806, a prioritization model 808 and a model calibrator 810 in one embodiment of the present disclosure. The resource and work packet tracking subsystem 804 identifies one or more work packets that have deviations from the planned schedule, e.g., as described above. The feature processing subsystem 806 identifies and computes features associated with those one or more work packets, e.g., as described above. The prioritization model 808 prioritizes or ranks the one or more work packets for attending to, e.g., as described above. A model calibrator 810 builds and updates the prioritization model 808 based on historical data, user input and further user feedback, e.g., as described above. The tracking and prioritization module 802 of the present disclosure in one embodiment may perform its functions continuously or as work in on-going. Thus, information associated with ongoing work 812 is monitored and tracked for schedule variance. Based on the tracking, prioritization and re-planning suggested by the tracking and prioritization module 802 of the present disclosure in one embodiment, a planner 814 may generate a new plan or re-plan a work schedule. The new plan is then input to a global demand queue 816, from which work is dequeued to be performed, e.g., at 812. The planner 814 also performs planning for work requests received at 818, which plans are queued to the demand queue 816.

FIG. 9 illustrates a schematic of an example computer or processing system that may implement a system in one embodiment of the present disclosure. The computer system is only one example of a suitable processing system and is not intended to suggest any limitation as to the scope of use or functionality of embodiments of the methodology described herein. The processing system shown may be operational with numerous other general purpose or special purpose computing system environments or configurations. Examples of well-known computing systems, environments, and/or configurations that may be suitable for use with the processing system shown in FIG. 9 may include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computer system may be described in the general context of computer system executable instructions, such as program modules, being executed by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

The components of computer system may include, but are not limited to, one or more processors or processing units 12, a system memory 16, and a bus 14 that couples various system components including system memory 16 to processor 12. The processor 12 may include a tracking and prioritization module 10 that performs the methods described herein. The module 10 may be programmed into the integrated circuits of the processor 12, or loaded from memory 16, storage device 18, or network 24 or combinations thereof.

Bus 14 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system may include a variety of computer system readable media. Such media may be any available media that is accessible by computer system, and it may include both volatile and non-volatile media, removable and non-removable media.

System memory 16 can include computer system readable media in the form of volatile memory, such as random access memory (RAM) and/or cache memory or others. Computer system may further include other removable/non-removable, volatile/non-volatile computer system storage media. By way of example only, storage system 18 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 14 by one or more data media interfaces.

Computer system may also communicate with one or more external devices 26 such as a keyboard, a pointing device, a display 28, etc.; one or more devices that enable a user to interact with computer system; and/or any devices (e.g., network card, modem, etc.) that enable computer system to communicate with one or more other computing devices. Such communication can occur via Input/Output (I/O) interfaces 20.

Still yet, computer system can communicate with one or more networks 24 such as a local area network (LAN), a general wide area network (WAN), and/or a public network (e.g., the Internet) via network adapter 22. As depicted, network adapter 22 communicates with the other components of computer system via bus 14. It should be understood that although not shown, other hardware and/or software components could be used in conjunction with computer system. Examples include, but are not limited to: microcode, device drivers, redundant processing units, external disk drive arrays, RAID systems, tape drives, and data archival storage systems, etc.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages, a scripting language such as Perl, VBS or similar languages, and/or functional languages such as Lisp and ML and logic-oriented languages such as Prolog. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The computer program product may comprise all the respective features enabling the implementation of the methodology described herein, and which—when loaded in a computer system—is able to carry out the methods. Computer program, software program, program, or software, in the present context means any expression, in any language, code or notation, of a set of instructions intended to cause a system having an information processing capability to perform a particular function either directly or after either or both of the following: (a) conversion to another language, code or notation; and/or (b) reproduction in a different material form.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Various aspects of the present disclosure may be embodied as a program, software, or computer instructions embodied in a computer or machine usable or readable medium, which causes the computer or machine to perform the steps of the method when executed on the computer, processor, and/or machine. A program storage device readable by a machine, tangibly embodying a program of instructions executable by the machine to perform various functionalities and methods described in the present disclosure is also provided.

The system and method of the present disclosure may be implemented and run on a general-purpose computer or special-purpose computer system. The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, and/or server. A module may be a component of a device, software, program, or system that implements some “functionality”, which can be embodied as software, hardware, firmware, electronic circuitry, or etc.

The embodiments described above are illustrative examples and it should not be construed that the present invention is limited to these particular embodiments. Thus, various changes and modifications may be effected by one skilled in the art without departing from the spirit or scope of the invention as defined in the appended claims.

We claim:

1. A system for accommodating schedule variance in work, comprising:
a processor;
a resource and work packet tracking subsystem operable to execute on the processor and further operable to track information associated with work packets, and further operable to identify one or more work packets deviating from a planned schedule based on the tracking;
a feature processing subsystem operable to collect data associated with the identified one or more work packets and further operable to identify features associated with the identified one or more work packets, and compute metrics associated with the features;
a prioritization model operable to prioritize the identified one or more work packets based on the computed metrics of the features, the prioritization model calibrated at least based on historical data,
wherein one or more actions to take are recommended for the one or more prioritized work packets.

2. The system of claim 1, further comprising a model calibrator operable to periodically calibrate the prioritization model based on additional data collected to keep the prioritization model up-to-date and to incorporate feedback on past prioritization performed by the prioritization model.

3. The system of claim 1, further comprising a capacity planner subsystem operable to generate a new plan for the identified one or more work packets.

4. The system of claim 1, further comprising a management portal operable to provide a user interface for interaction between a user and the system for accommodating schedule variance in work.

5. The system of claim 1, wherein resource and work packet tracking subsystem identifies the one or more work packets deviating from a planned schedule based on comparing observed data during tracking with a semantic model.

6. A computer readable storage medium storing a program of instructions executable by a machine to perform a method of accommodating schedule variance in work, comprising:
tracking information associated with work packets;
identifying one or more work packets deviating from a planned schedule based on the tracking;
identifying one or more features associated with the identified one or more work packets;
computing metrics associated with the one or more features;
prioritizing the identified one or more work packets based on the computed metrics using a predictive model, the predictive model calibrated at least based on historical data; and
recommending one or more actions to take associated with the one or more prioritized work packets.

7. The computer readable storage medium of claim 6, wherein the tracking comprises tracking information associated with work packets in a global service delivery system.

8. The computer readable storage medium of claim 6, wherein the predictive model is calibrated further based on feedback from one or more users.

9. The computer readable storage medium of claim 6, wherein the predictive model is updated with up-to-date data and feedback from a user.

10. The computer readable storage medium of claim 6, wherein the tracking comprising observing status and amount of time spent associated with the work packets and comparing the observed status and amount of time with an estimation.
